(19) United States
(12) Patent Application Publication
(10) Pub. No.: US 2017/0260868 A1
(43) Pub. Date: Sep. 14, 2017

(54) METHOD OF TREATING A BRUSH SEAL, TREATED BRUSH SEAL, AND BRUSH SEAL ASSEMBLY

(71) Applicant: GENERAL ELECTRIC COMPANY, Schenectady, NY (US)

(72) Inventors: Dechao LIN, Greer, SC (US); David Vincent BUCCI, Simpsonville, SC (US)

(21) Appl. No.: 15/067,253

(22) Filed: Mar. 11, 2016

(51) Int. Cl. F01D 11/00; F16J 15/3288

(52) U.S. Cl. CPC F01D 11/003; F16J 15/3288; F05D 2220/31; F05D 2220/32; F05D 2240/56; F05D 2300/701; F05D 2300/17

(57) ABSTRACT

A method treats a brush seal at a tip end of the brush seal. The method includes contacting the tip end of the brush seal to an oxidation-resistant, wear-resistant coating composition and heat-treating a distal portion of the bristles to form an oxidation-resistant, wear-resistant coating on the distal portion from the oxidation-resistant, wear-resistant coating composition. A brush seal includes a brush support and bristles extending from the brush support with a distal portion coated by an aluminide diffusion coating. A brush seal assembly includes a non-rotary component and a rotary component. The non-rotary component includes a brush seal including a bristle pack. The bristle pack includes bristles extending from a brush support with a distal portion coated by an aluminide diffusion coating. The rotary component has a sealing surface contacting the distal portion of the brush seal to form a turbine seal between the rotary component and the non-rotary component.

### FIELD OF THE INVENTION

The present embodiments are directed to power generation systems, and more specifically to brush seals that provide improved wear and oxidation properties while maintaining the sealing system in the power generation system.

### BACKGROUND OF THE INVENTION

Brush seals are conventionally employed for forming a seal between non-rotary and rotary components and between high- and low-pressure regions on opposite sides of the seal. In power generation systems, seals between non-rotary and rotary components include packing about a rotary shaft. Power generation systems include, but are not limited to, gas turbines and steam turbines. Conventional bristle packs, particularly those exposed to high-temperature environments, require precise placement of superalloy bristles while maintaining tight tolerances.

The high-pressure, high-temperature environment of the brush seal, as well as cyclic fatigue, causes bristle instability over time. A brush seal loses its pressure capability over time due to bristle instability, eventually leading to fluttering and rapid failure. To reduce the wear of the matching rotor, the bristles of the brush seal are typically small in diameter, generally about 0.13 mm. Metallic brush seals in contact with uncoated rotors undergo severe wear if the rotor incursions are beyond 0.5 mm. Uncoated rotors undergo wear, thereby generating a rough surface, and in turn causing more wear on the bristles in the brush assembly.

Hard, smooth, wear-resistant coatings, such as CrC—NiCr or CrC—NiCr—Ag—CaF₂BaF₂, have been applied to rotors in the past to address the wear on the bristles in the brush assembly. The hard, smooth, wear-resistant coatings polish the bristles instead of wearing away the bristles. When dealing with brush seal assembly wear issues in the field, an entire rotor in a gas turbine or steam turbine is conventionally removed and brought in to a shop to re-apply the wear-resistant coatings. Additionally, accommodating large rotors in a small spray cell to apply the wear-resistant coatings may pose significant difficulties.

### BRIEF DESCRIPTION OF THE INVENTION

In an embodiment, a method treats a brush seal including a plurality of bristles at a tip end of the brush seal. The method includes contacting the tip end of the brush seal to an oxidation-resistant coating composition and heat-treating a distal portion of the bristles to form an oxidation-resistant coating on the distal portion from the oxidation-resistant coating composition.

In another embodiment, a brush seal includes a brush support and bristles extending in a bristle pack from the brush support. The distal portion of the bristle pack is coated by an aluminide diffusion coating.

In another embodiment, a brush seal assembly includes a non-rotary component and a rotary component. The non-rotary component includes a brush seal including a brush support and a bristle pack. The bristle pack includes bristles extending from the brush support with a distal portion coated by an aluminide diffusion coating. The rotary component has a sealing surface contacting the distal portion of the brush seal to form a turbine seal between the rotary component and the non-rotary component.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic perspective view of a brush seal assembly in an embodiment of the present disclosure.

FIG. 2 is a schematic side view of a brush seal assembly in an embodiment of the present disclosure.

FIG. 3 is a schematic back view of the brush seal assembly of FIG. 2.

FIG. 4 is a schematic end view of a bristle pack of the brush seal of FIG. 2.

Wherever possible, the same reference numbers will be used throughout the drawings to represent the same parts.

### DETAILED DESCRIPTION OF THE INVENTION

Provided is a method of treating a brush seal to form an aluminide diffusion coating on the distal end of the bristles of the brush seal and a brush seal and a brush seal assembly with a distal end of the bristles coated with an aluminide diffusion coating.

Embodiments of the present disclosure, for example, in comparison to concepts failing to include one or more of the features disclosed herein, increase the oxidation resistance of a brush seal, reduce rotary component wear, increase brush seal bristle stiffness, provide a longer brush seal service time, improve the properties of the brush seal bristles at the tip portion, reduce the frequency of rotary component repair of damage caused by rubbing between the brush seal and the rotary component, or combinations thereof.

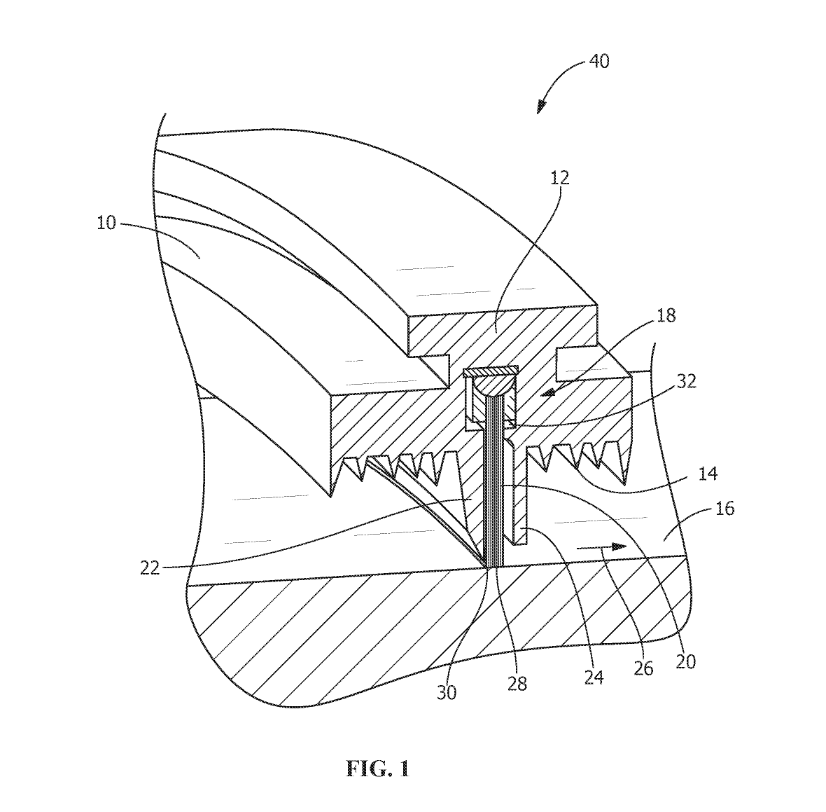

Referring to FIG. 1, a brush seal assembly 40 includes a brush support 10, a brush seal 18, and a rotary component 16. The brush support 10 includes a dovetail 12 on one side for securement to a non-rotary component (not shown) and a plurality of labyrinth teeth 14 (optional) on the opposite side facing a rotary component 16. In other embodiments, the brush support 10 may be integral with the non-rotary component. The illustrated brush support 10 is a packing ring. In some embodiments, the rotary component 16 is a turbine rotor. The brush seal 18 extends from the brush support 10 to form a seal between the brush support 10 and the rotary component 16. The brush seal 18 includes a plurality of bristles disposed as a bristle pack 20 within a slot held between and extending past a front pressure plate 22 and a back fence plate 24 of the brush support 10. The bristle pack 20 extends out past the front pressure plate 22 and back fence plate 24 to a coated tip end 30 that contacts the surface of the rotary component 16. The brush seal 18 includes rails 32 to hold the bristles of the bristle pack 20 together in place.

The bristles of the bristle pack 20 are coated at their tip ends 30 with an oxidation-resistant, wear-resistant coating 28. The coated tip ends 30 of the bristles engage along the surface of the rotary component 16. The general direction of fluid flow 26 is indicated by the arrow in FIG. 1. The brush support 10 may be formed in segments to complete an annular brush seal assembly 40 about the rotary component 16. Set screws (not shown) along the outer diameter of the brush support 10 may be used to secure the brush seal 18 in the packing ring slot. In some embodiments, the brush seal assembly 40 is part of a gas turbine system. In other embodiments, the brush seal assembly 40 is part of a steam turbine system.

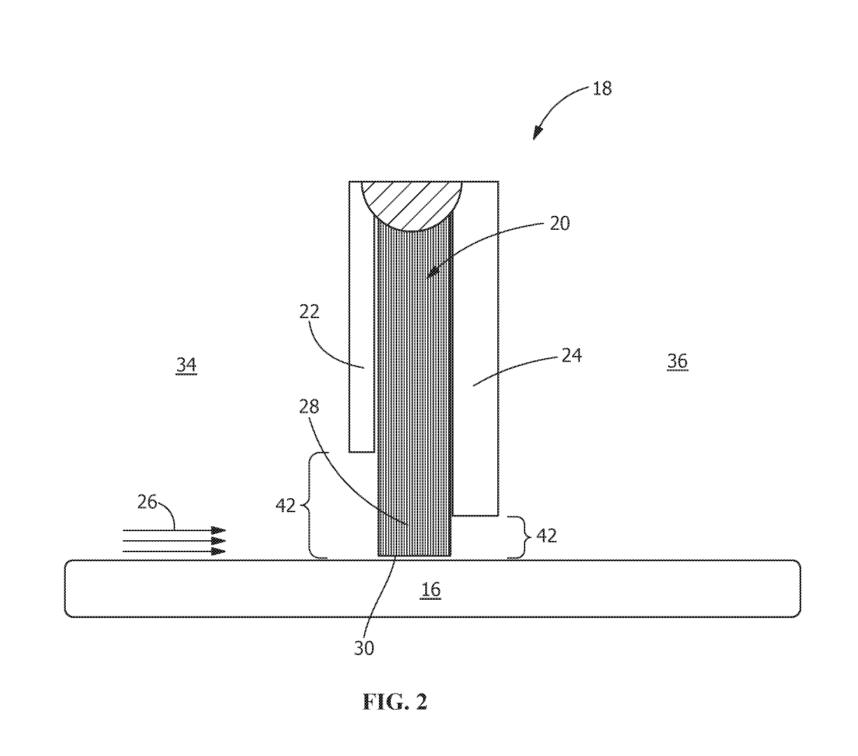

Referring to FIG. 2, the brush seal 18 forms a seal separating a high-pressure side 34 and a low-pressure side 36, with the general direction of fluid flow 26, as shown. The bristles of the bristle pack 20 are coated at their tip ends 30 with an oxidation-resistant, wear-resistant coating 28. In some embodiments, the oxidation-resistant, wear-resistant coating 28 covers a distal portion 42 of the bristles extending up to or past the back fence plate 24. In some embodiments, the oxidation-resistant, wear-resistant coating 28 covers a distal portion 42 of the bristles extending up to or past the front pressure plate 22. The coated distal portion 42 may be any portion from the tip ends 30 to any point below the bottom edge of the front pressure plate 22 or the back fence plate 24, between the bottom edges of the front pressure plate 22 and the back fence plate 24 or above the bottom edges of the front pressure plate 22 and the back fence plate 24.

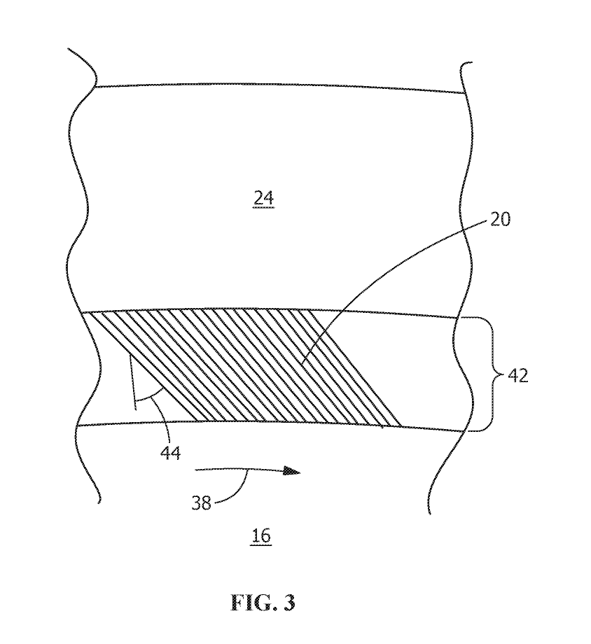

Referring to FIG. 3, the bristles of the bristle pack 20 may be angled or canted at a tilt angle 44 in the direction of rotation 38 of the rotary component 16, with each bristle forming a tilt angle 44 that is acute with an intersecting radius of the rotary component 16. In some embodiments, the tilt angle 44 is in the range of about 40 to about 50 degrees, alternatively about 42 to about 48 degrees, alternatively, about 44 to about 46 degrees, alternatively about 45 degrees, or any suitable combination, sub-combination, range, or sub-range thereof.

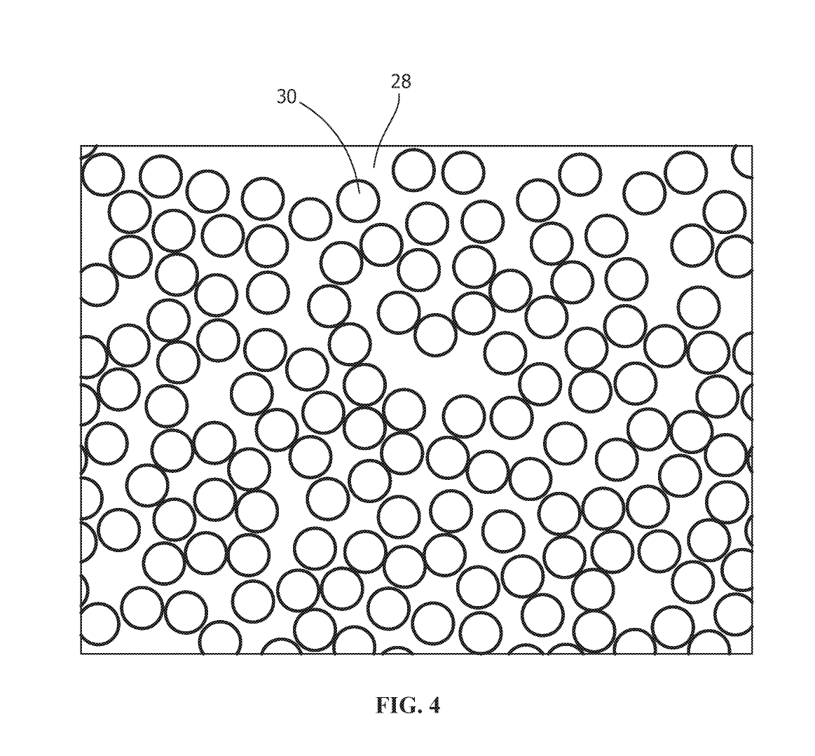

FIG. 4 shows an arrangement of the tip ends 30 of the distal portion 42 of some of the inner bristles from a micrograph of a bristle pack 20 coated by a method of the present disclosure. Methods of the present disclosure preferably coat inner bristle surfaces with oxidation-resistant, wear-resistant coatings 28 that are fairly uniform despite the non-uniformity of the spaces between bristles.

In some embodiments, a method coats a distal portion 42 of the bristles of a brush seal 18 by contacting the tip ends 30 of the bristle pack 20 to an aluminide slurry. The method preferably coats the tip ends 30 of all of the bristles of the bristle pack 20. The oxidation-resistant, wear-resistant coating 28 preferably increases the oxidation resistance of the brush seal 18 and the stiffness of the bristles and reduces the wear of the rotary component 16 from contact with the bristles during service. As used herein, “tip end” refers to an end of a bristle facing the rotary component 16 in a brush seal assembly 40.

The oxidation-resistant, wear-resistant coating composition may be applied to the tips of the bristles from any vapor source, liquid source, or slurry source by any contacting method, including, but not limited to, spraying, dipping, brushing, injecting, pack cementation, above-the-pack vapor, true chemical vapor deposition, or combinations thereof. Contacting, as used herein, may refer to movement of the coating source, movement of the bristles, or movement of both the coating source and the bristles. In some embodiments, the contacting includes dipping the tips of the bristles into the coating material. In some embodiments, the coating material is a slurry. In some embodiments, the method of coating is performed on the bristle pack 20 prior to mounting the bristle pack 20 in the brush support 10. In other embodiments, the method of coating is performed on the bristle pack 20 with the bristle pack 20 mounted in the brush support 10.

In some embodiments, the oxidation-resistant, wear-resistant coating is an aluminide diffusion coating applied to the bristles as an oxidation-resistant, wear-resistant coating composition of one or more slurries in one or more application steps. The aluminide slurry preferably includes a donor material powder containing a metallic aluminum alloy having a melting temperature higher than aluminum, an activator capable of forming a reactive halide vapor with the metallic aluminum, and a binder containing an organic polymer, which may include, but is not limited to, an alcohol-based organic polymer, a water-based organic polymer, or a combination thereof. The donor material powder preferably has a particle size of 200 mesh (74 microns) or less. In some embodiments, the donor material is a chromium-aluminum alloy. Suitable halide activators include, but are not limited to, ammonium chloride (NH₄Cl), ammonium fluoride (NH₄F), and ammonium bromide (NH₄Br). Suitable alcohol-based polymers include, but are not limited to, low molecular weight polyalcohols (polyols), including, but not limited to, polyvinyl alcohol (PVA). Suitable water-based organic polymers include, but are not limited to, a polymeric gel available under the name Vitta Braz-Binder Gel (Vitta Corporation, Bethel, Conn.).

The aluminide slurry preferably contains about 35 to about 65% donor material powder, about 1 to about 25% activator, and about 25 to about 60% binder. The aluminide slurry preferable is capable of forming an aluminide layer without any inert fillers or binders that leave residues. In some embodiments, the aluminide slurry does not contain any inert fillers or binders that leave residues.

In some embodiments, the bristles are coated by the application of two different aluminide slurries. The first aluminide slurry applied to the bristles is thinner and less viscous than the second so that the distal portion 42 of the interior bristles is coated with the first slurry more easily with the aid of capillary action. The thicker, more viscous second aluminide slurry provides a second layer to the distal portion 42 of at least the exterior bristles of the bristle pack 20. The more viscous second aluminide slurry preferably has a greater percentage of solids (donor material powder) and more activator than the less viscous first aluminide slurry to produce the higher viscosity. As the outer bristle surfaces in the distal portion 42 face a more severe oxidation environment during service, an oxidation-resistant, wear-resistant coating 28 on the outer bristle surfaces in the distal portion is more important than on the inner bristle surfaces, but it is still advantageous to use a low viscosity first aluminide slurry to increase the coverage on the inner bristle surfaces in the distal portion 42.

The two-step coating process preferably builds up a local coating environment so that all or substantially all of the bristles are coated at the distal portion 42. In some embodiments, the first aluminide slurry is applied by dipping the tip ends 30 of the bristle pack 20 into the first aluminide slurry a predetermined distance. In some embodiments, the predetermined distance is at least the distance from the tip end of the bristles to the distal end of the back fence plate 24. In some embodiments, the predetermined distance is at least the distance from the tip end 30 of the bristles to the distal end of the front pressure plate 22. In some embodiments, the distance is equal to the length of the distal portion 42 that receives the oxidation-resistant, wear-resistant coating 28. In some embodiments, the distance may be less than the length of the distal portion 42 due to capillary action. The first aluminide slurry is preferably allowed to dry prior to the application of the second aluminide slurry. This drying may occur in an open air environment or in a controlled environment with an elevated temperature and/or a reduced pressure. In some embodiments, the elevated temperature is in the range of about 93 to about 149° C. (about 200 to about 300° F.). The second aluminide slurry, having a higher viscosity, tends to cover primarily the outer surfaces in the distal portion 42. While the second aluminide slurry may be applied by dipping, it may alternatively be applied by alternative methods, including, but not limited to, spraying, brushing, or dripping, with similar results.

The distal portion 42 of the bristle pack 20 is preferably subjected to a heat treatment after application of the last aluminide slurry to form an aluminide layer of the oxidation-resistant, wear-resistant coating 28. The heat treatment preferably includes heating the distal portion 42 to a temperature in the range of about 815 to about 1150° C. (about 1500 to about 2100° F.), alternatively about 980 to about 1095° C. (about 1800 to about 2000° F.), alternatively about 1010 to about 1065° C. (about 1850 to about 1950° F.), alternatively about 1040° C. (about 1900° F.), or any suitable combination, sub-combination, range, or sub-range thereof, for about one to about eight hours, alternatively about two to about six hours, alternatively about three to about five hours, alternatively about four hours, or any suitable combination, sub-combination, range, or sub-range thereof.

In other embodiments, other methods and types of oxidation-resistant, wear-resistant coatings 28 may be used depending on the brush seal application and location of the brush seal 18 in the turbine.

The oxidation-resistant, wear-resistant coating 28 may have a thickness of about 5 microns (0.2 mil) to about 20 microns (0.8 mil), alternatively about 10 microns (0.4 mil) to about 15 microns (0.6 mil), or any suitable combination, sub-combination, range, or sub-range thereof. In some embodiments, the coating thickness on the bristles is about 13 microns (0.5 mil) to make the bristles stiffer with a higher oxidation resistance capability. The uncoated bristles may have a diameter of about 50 to about 500 microns (about 2 to about 20 mil), alternatively about 75 to about 250 microns (about 3 to about 10 mil), alternatively about 100 microns (about 4 mil) to about 150 microns (about 6 mil), or any suitable combination, sub-combination, range, or sub-range thereof. In some embodiments, the diameter of the uncoated bristles is about 130 microns (about 5 mil). The presence of an oxidation-resistant, wear-resistant coating 28 on each bristle preferably makes the bristle more brittle on its outer surface, thereby reducing the wear rate of the rotary component 16.

The coating method is preferably robust and applicable to different brush seal applications, configurations, locations, and materials. The oxidation-resistant, wear-resistant coating 28 preferably improves the local bristle properties by increase oxidation resistance, increasing the stiffness of the bristles to maintain the pressure capability of the brush seal 18, and reducing wear on the rotary component 16 as a result of the greater brittleness of the tip ends 30 of the bristles.

The bristles are preferably made of a metal material, which may include, but is not limited to, a stainless steel, a nickel-based alloy, or a high temperature alloy, which may include, but is not limited to, a cobalt-based superalloy. The bristle material is preferably selected to help maintain the shape and orientation of the bristle and to provide wear-resistance. Suitable materials for the bristles include, but are not limited to, Haynes® 25 alloy, Haynes®188 alloy, or Hastelloy® C-276 alloy (Haynes International, Inc., Kokomo, Ind.), or Nitronic 60® (AK Steel Corp., Middletown, Ohio).

As used herein, “Haynes® 25 alloy” refers to an alloy including a composition, by weight, of about 20% chromium, about 15% tungsten, about 10% nickel, up to about 3% iron, about 1.5% manganese, up to about 0.4% silicon, about 0.1% carbon, and a balance of cobalt.

As used herein, “Haynes®188 alloy” refers to an alloy including a composition, by weight, of about 22% nickel, about 22% chromium, about 14% tungsten, up to about 3% iron, up to about 1.25% manganese, about 0.35% silicon, about 0.1% carbon, about 0.03% lanthanum, up to about 0.015% boron, and a balance of cobalt.

As used herein, “Hastelloy® C-276 alloy” refers to an alloy including a composition, by weight, of about 16% chromium, about 16% molybdenum, about 5% iron, about 4% tungsten, up to about 2.5% cobalt, up to about 1% manganese, up to about 0.35% vanadium, up to about 0.08% silicon, up to about 0.01% carbon, and a balance of nickel.

As used herein, “Nitronic 60®” refers to an alloy including a composition, by weight, of about 16-17% chromium, about 8-8.5% nickel, about 7.5-8.5% manganese, about 3.7-4.2% silicon, up to about 0.75% molybdenum, up to about 0.75% copper, about 0.1-0.18% nitrogen, up to about 0.2% vanadium, up to about 0.15% tungsten, up to about 0.1% niobium, about 0.06-0.08% carbon, up to about 0.05% titanium, up to about 0.05% tin, up to about 0.04% phosphorus, up to about 0.03% sulfur, up to about 0.02% aluminum, up to about 0.0015% boron, and a balance of iron.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A method of treating a brush seal comprising a plurality of bristles at a tip end of the brush seal, the method comprising:
contacting the tip end of the brush seal to an oxidation-resistant, wear-resistant coating composition; and
heat-treating a distal portion of the plurality of bristles comprising the tip end of the brush seal to form an oxidation-resistant, wear-resistant coating on the distal portion from the oxidation-resistant, wear-resistant coating composition.

2. The method of claim 1 wherein the oxidation-resistant, wear-resistant coating comprises a first aluminide slurry selected to have a first viscosity to permit the first aluminide slurry to penetrate spaces between the plurality of bristles by capillary action.

3. The method of claim 2 further comprising contacting the tip end of the brush seal to a second aluminide slurry having a second viscosity greater than the first viscosity of the first aluminide slurry to coat the distal portion of the plurality of bristles with the second aluminide slurry.

4. The method of claim 3 further comprising drying the first aluminide slurry on the distal portion before contacting the tip end of the brush seal to the second aluminide slurry.

5. The method of claim 1 wherein the plurality of bristles have a diameter in a range of about 100 microns to about 150 microns and the oxidation-resistant, wear-resistant coating has a coating thickness in a range of about 10 microns to about 15 microns.

6. The method of claim 1 wherein contacting the tip end of the brush seal to the oxidation-resistant, wear-resistant coating composition comprises spraying, dipping, brushing, injecting, pack cementation, above-the-pack vapor, chemical vapor deposition, or combinations thereof.

7. The method of claim 1 wherein the plurality of bristles comprise a metal selected from the group consisting of a stainless steel, a nickel-based alloy, and a cobalt-based superalloy.

8. A brush seal comprising:
a brush support; and
a plurality of bristles extending in a bristle pack from the brush support, the bristle pack having a distal portion coated by an aluminide diffusion coating.

9. The brush seal of claim 8 wherein the aluminide diffusion coating comprises a first aluminide layer deposited on the distal portion from a first aluminide slurry having a first viscosity and a second aluminide layer deposited on the first aluminide layer from a second aluminide slurry having a second viscosity greater than the first viscosity.

10. The brush seal of claim 8 wherein the aluminide diffusion coating has a coating thickness in a range of about 10 microns to about 15 microns.

11. The brush seal of claim 8 wherein the plurality of bristles have a diameter in a range of about 100 microns to about 150 microns.

12. The brush seal of claim 8 wherein the plurality of bristles comprise a metal selected from the group consisting of a stainless steel, a nickel-based alloy, and a cobalt-based superalloy.

13. The brush seal of claim 8 wherein the aluminide diffusion coating has a coating brittleness greater than a bristle brittleness of the plurality of bristles.

14. The brush seal of claim 8 wherein the brush support comprises a front plate and a back plate forming a slot, and wherein the distal portion of the bristle pack extends from the slot.

15. A brush seal assembly comprising:
a non-rotary component comprising a brush seal comprising a brush support and a bristle pack, the bristle pack comprising a plurality of bristles extending from the brush support, the bristle pack having a distal portion coated by an aluminide diffusion coating; and
a rotary component having a sealing surface contacting the distal portion of the brush seal to form a turbine seal between the rotary component and the non-rotary component.

16. The brush seal assembly of claim 15 wherein the aluminide diffusion coating comprises a first aluminide layer deposited from a first aluminide slurry and a second aluminide layer deposited from a second aluminide slurry.

17. The brush seal assembly of claim 15 wherein the aluminide diffusion coating has a coating thickness in a range of about 10 microns to about 15 microns.

18. The brush seal assembly of claim 15 wherein the plurality of bristles have a diameter in a range of about 100 microns to about 150 microns.

19. The brush seal assembly of claim 15 wherein the plurality of bristles are made of a metal selected from the group consisting of a stainless steel, a nickel-based alloy, and a cobalt-based superalloy.

20. The brush seal assembly of claim 15 wherein the rotary component is a turbine rotor.
